(19) United States
(12) Patent Application Publication
(10) Pub. No.: US 2017/0039826 A1
(43) Pub. Date: Feb. 9, 2017

(54) Fibre Optic Distributed Sensing for Perimeter Monitoring

(71) Applicant: OPTASENSE HOLDINGS LIMITED, Farnborough, Hampshire (GB)

(72) Inventor: Constantin Cojocaur, Craoiva (RO)

(21) Appl. No.: 15/304,161

(22) PCT Filed: Apr. 15, 2015
(86) PCT No.: PCT/GB2015/051147

§ 371 Date: Oct. 14, 2016

(30) Foreign Application Priority Data
Apr. 16, 2014 (GB) 1406912.4

(51) Int. Cl. G08B 13/12

(52) U.S. Cl. CPC G08B 13/124

(57) ABSTRACT

This application relates to apparatus and methods for monitoring of a perimeter having a barrier (101) such as a chain-link fence. The system (100) has a sensing optical fibre (102) suitable for fibre optic distributed acoustic sensing (DAS) deployed along at least part of said perimeter, with at least part of the sensing optical fibre being buried, e.g. in the ground (104) in the vicinity of the barrier. In addition the sensing fibre is mechanically coupled to at least one vibration transmitting element (106) which is mechanically coupled to the barrier. In use the sensing fibre is interrogated by a DAS sensor unit (103). Being buried the sensing fibre is hidden from view, protected from sabotage and has good acoustic coupling to the ground, e.g. for detecting disturbances of the ground. The vibration transmitting elements ensure that any disturbance of the barrier, e.g. fence, itself is also well coupled to the sensing fibre and can be detected.

This application relates to methods and apparatus for perimeter monitoring using fibre optic based distributed sensing and in particular to monitoring of a barrier, such as a wire fence, using fibre optic distributed acoustic sensing.

Various methods are known for securing borders and perimeters, for instance perimeters of sites where access is to be controlled. At a basic level some sort of fence or barrier may be deployed along the perimeter to restrict access, other than at certain designated entry points. The fences used are often wire or chain-link fences as such fences can be relatively inexpensive in terms of materials and can be readily installed in the desired location. Wire or chain-link fences may be useful as they have a relatively low visual impact on the landscape and the ability to see through such a fence can be advantageous in such instances to allow ease of patrolling etc.—although the fences can be covered with an opaque material if desired.

In some instances a border or perimeter may be secured not only by arranging a physical barrier such as a fence but the perimeter may also have some sort of intrusion detection system.

Intrusion detection systems for perimeter monitoring may be implemented using a number of different technologies. For instance cameras, in the visual or infrared bands say, may be arranged to monitor the perimeter with the output of the cameras being monitored by security personnel and/or subject to automated image processing to detect intruders. However monitoring a relatively long border with cameras would require a relatively large number of cameras, which may be costly, and having security personnel monitoring the output of a large number of different cameras may run the risk of an intruder being missed.

More simple infrared sensors that don't form an image may be used to detect intruders. Again however this requires a number of sensors being deployed at required points, which may require a large number of individual sensors and may be quite costly for relatively long borders.

In some applications the fence itself may be provided with one or more intrusion monitoring systems. For instance one or more electrical conductors may be arranged to run through the fence, for at least part of the perimeter, so as to complete an electrical circuit. The electrical properties may be monitored in use. In the event that an intruder cuts or otherwise breaks through part of the fence, the relevant electrical conductors may also be severed, thus breaking the electrical circuit. This can be detected and used to indicate a break in the fence, signalling a possible intruder. A similar approach involves use of an optical waveguide, such as a fibre optic, threaded through the fence. In use light is transmitted through the fibre optic and detected at the end. A break in the fibre optic caused by a break in the fence will result in light no longer being detected at the detector which could signal an intruder. In such systems however an intruder may be able to cut through a section of fence that does not include a conductor or fibre optic and thus avoid detection. Likewise an intruder climbing over the fence would not be detected by such methods. It is also possible for a potential intruder to sabotage such a system by cutting through the conductor or fibre optic.

Distributed acoustic sensing (DAS) has been proposed for intrusion monitoring. DAS is a known type of sensing in which an optical fibre is deployed as a sensing fibre and repeatedly interrogated with electromagnetic radiation to provide sensing of acoustic/vibrational activity along its length. For intrusion monitoring one or more sensing fibres may be deployed along the perimeter to be monitored. The movement of vehicles or personnel near the perimeter or activities such as digging can generate acoustic signals in the ground which can propagate to the sensing fibre. The sensing fibre can be monitored for the occurrence of any significant unexpected disturbances which could potentially indicate an intruder.

Embodiments of the present invention relate to improved methods and apparatus for monitoring of borders or perimeters having fences or barriers or the like.

Thus according to the present invention there is provided a system for monitoring a perimeter having a barrier comprising:
a sensing optical fibre suitable for fibre optic distributed acoustic sensing deployed along at least part of said perimeter;
at least part of said sensing optical fibre being buried in the vicinity of at least part of said barrier;
wherein the sensing fibre is mechanically coupled to at least one vibration transmitting element which is mechanically coupled to the barrier.

The barrier may comprise a fence, such as a chain-link or wire fence.

The vibration transmitting element may be coupled to the optical fibre below ground and/or the vibration transmitting element may additionally or alternatively be coupled to the barrier above ground. The vibration transmitting element may be coupled to the barrier in multiple places.

In some embodiments the vibration transmitting element comprises an elongate rigid element. The vibration transmitting element may comprise a rod or stick. The vibration transmitting element may extend for at least half the height of the barrier. The end of the vibration transmitting element that is coupled to the sensing fibre may comprise a portion aligned with the direction of the sensing fibre.

In some embodiments the vibration transmitting element comprises a cable. The cable may be under tension.

In some embodiments the vibration transmitting element comprises a movable part which is coupled to the sensing optical fibre and the fence and at least one shield or guiding component that allows the movable part to move.

The sensing fibre may not be visible from above ground in the vicinity of the barrier. At least parts of the sensing fibre may directly underlie the fence. At least parts of the sensing fibre may be buried to lie outside the perimeter.

In use a distributed acoustic sensor may be coupled to one end of said sensing fibre. The DAS sensor may be configured to produce a measurement signal from each of a plurality of sensing portions disposed along the length of the sensing optical fibre, and the system may further comprise a processor configured to monitor the measurement signal from each sensing channel for any signal indicating a potential intruder. The processor may be configured to analyse said measurement signals for any significant disturbance in an area where, and/or at a time when, no such disturbance is expected. The processor may discriminate between a disturbance due to disturbance of the ground in the vicinity of perimeter and a disturbance due to interference with the fence itself. The processor may discriminate between a disturbance due to disturbance of the ground in the vicinity of perimeter and a disturbance due to interference with the fence itself by analysing any high frequency component of the measurement signals.

In general the distributed acoustic sensor may analyse the amount of high frequency content in the measurement signal from a sensing portion of the sensing fibre to detect an event associated with interference with said barrier.

Other aspects of the invention relate to a method of perimeter monitoring using a sensing optical fibre, at least a part of which is buried in the vicinity of a barrier and which is mechanically coupled to a vibrational transmitting element which is itself mechanically coupled to the barrier. Another aspect of the invention relates to the use of such a sensing optical fibre and to method for processing data acquired from such a sensing optical fibre by a DAS sensor.

Any of the variants discussed above in relation to the first aspect are also equally applicable to the other aspects of the invention.

The invention will now be described by way of example only with reference to the following drawings, of which:

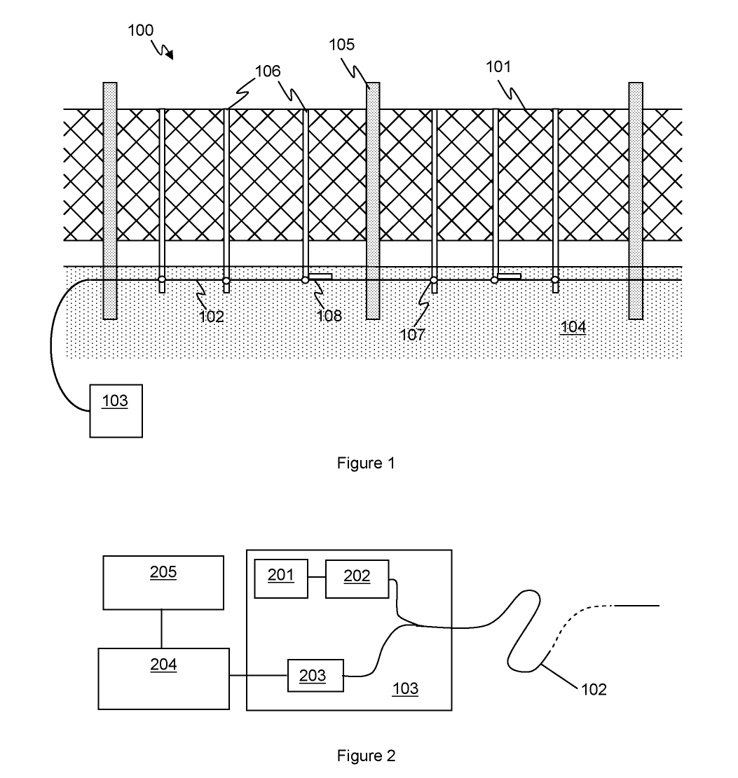

FIG. 1 illustrates a perimeter monitoring system according to the present invention;

FIG. 2 illustrates a fibre optic distributed acoustic sensor;

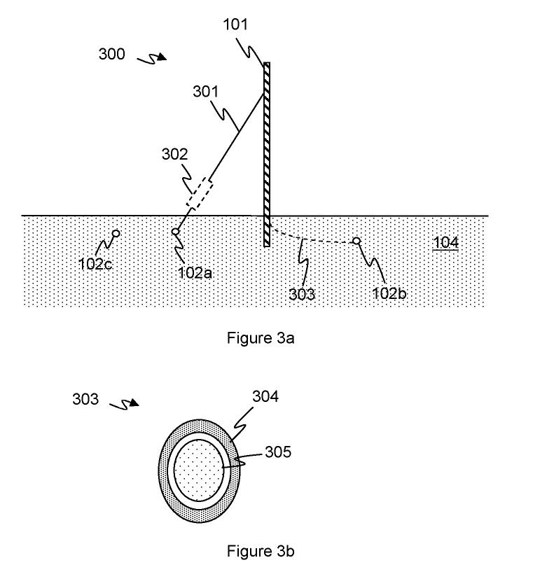

FIG. 3a illustrates a perimeter monitoring system according to a further embodiment of the present invention; and

FIG. 3b illustrates a vibration transfer element according to an embodiment.

Embodiments of the present invention relate to methods and apparatus for perimeter monitoring that use distributed acoustic sensing to provide monitoring of a perimeter having a barrier such as a fence, especially a wire or chain-link fence or the like that is at least partly flexible. Distributed acoustic sensing is performed on at least one sensing fibre which is located in the vicinity of the perimeter, i.e. the barrier, to be monitored. Preferably at least part of the sensing fibre is buried in the ground in the vicinity of the barrier. In embodiments of the invention the sensing fibre is mechanically coupled to at least one vibration transmitting element which is coupled to (or forms part of) the barrier. The or each vibration transmitting element is coupled to the barrier such that movement, e.g. vibration, of the barrier is transmitted to the sensing fibre. Preferably the vibration transmitting element is coupled to the optical fibre below ground and coupled to the barrier above ground.

FIG. 1 illustrates a perimeter monitoring system 100 according to an embodiment of the present invention. FIG. 1 illustrates a barrier 101, which in this embodiment is a chain-link fence. As mentioned above chain-link fences are used in a range of different applications to provide perimeter security. Chain-link fences can be a relatively inexpensive way to prevent ready access past or beyond a perimeter. The perimeter monitoring is provided by sensing optical fibre 102 which is connected to interrogator unit 103 to perform distributed acoustic sensing (DAS) on the sensing optical fibre 102.

The sensing optical fibre is buried in the ground 104 in the vicinity of the fence so that at least part of the sensing fibre runs generally along the path of at least part of the fence. As will be described in more detail below DAS can be reliably performed on optical fibres of lengths of up to 40 km or more. Thus a perimeter or border of up to 40 km can be monitored by a single DAS sensor. For longer borders or perimeters multiple DAS sensor each with sensing fibres could be arranged to cover the entire length it is wished to monitor. For shorter perimeters/borders the optical fibre length may be matched to the length of the perimeter/border to be monitored. However in some embodiments the sensing optical fibre 102 may be deployed so that at least some parts of the perimeter/border are monitored by different sections of the same sensing fibre, for instance the sensing fibre could be arranged to lie in multiple loops around the perimeter or border of interest and/or with at least some sections where the path of the fibre meanders with respect to the path of the perimeter.

The chain-link fence 101 in the embodiment illustrated in FIG. 1 comprises chain link fence panels which are separated by and supported by fence supports 105 which may, for instance be partly buried in the ground 104. In embodiments of the invention the sensing optical fibre is mechanically coupled to at least one member 106 which is coupled to the barrier, i.e. the fence 101. The member 106 may be coupled to the fence 106 in any convenient way such that movement of the fence causes movement of the member 106. In one embodiment the members 106 may comprise elongate rods or sticks or relatively thin but relatively rigid elements, e.g. metal tick sticks. The members 106 may be coupled to the chain-link fence in a number of different places by ties, coupling rings or the like and/or may be woven into the mesh of the fence. Conveniently the members may extend for a significant height of the fence panel, e.g. to at least half the height of the fence panel but in some embodiments the members 106 may be coupled to just the lower part of the fence, e.g. a fence panel. The members 106 are mechanically coupled to the sensing optical fibre by any suitable coupling 107 such that movement of the member 106 translates to vibration of the sensing fibre 102, e.g. by suitable ties. In some embodiments the sensing optical fibre may be wound around the members 106 and/or may pass through channels in the members, but such embodiments may add to the complexity of installation. In some embodiments the bottom part 108 of at least some members 106 may be arranged to align with the sensing fibre 102 to improve acoustic coupling, e.g. the lower part of the member 106 may be shaped or bent so as to run along the direction of the sensing fibre 102.

Burying the sensing optical fibre used for DAS has several advantages. The sensing fibre is covert in that it is not visible from above ground. This can help disguise the fact that the fence has a monitoring system and can make it harder for an intruder to try to disrupt the monitoring system, say by severing the sensing fibre in one location and then trying to subsequently gain entry at a different location. Depending on the form of the members 106 the sensing fibre may be buried so that at least parts of the sensing fibre directly underlie the fence and/or so as least parts of the sensing fibre are located so as to be within the perimeter to be secured, i.e. slightly inset from the fence, so that it can't readily be interfered with from outside the fence. Alternatively at least parts of the sensing fibre could be buried to lie outside the perimeter, i.e. fence so as to maximise the sensitivity to vibrations imparted to the ground from outside the perimeter, e.g. from movement of personnel or vehicles or of disturbance of the ground outside the perimeter.

By being buried the sensing fibre will be isolated from environmental effects such as rain or wind that could affect operation of the DAS sensor were the sensing fibre to be exposed, e.g. were a sensing fibre for DAS to be directly coupled to the fence panels, and which may otherwise cause a reduction in signal to noise ratio.

Being buried also means that the sensing optical fibre should have good acoustic coupling to the ground and thus may be relatively sensitive to vibrations transmitted via the ground. This means that the DAS sensor can readily detect personnel and vehicles moving outside the perimeter that cause vibrations to be transmitted through the ground to the fibre. The DAS sensor will be relatively sensitive to any digging or excavation of the ground in the vicinity of the perimeter. Thus the perimeter monitoring system will also be responsive to any attempt to tunnel under the fence which may not actually disturb the fence itself.

Were the sensing optical fibre to just be laid on top of the ground any acoustic signals corresponding to movement of personnel or vehicles may not couple well to the acoustic fibre. Were the sensing fibre to be coupled directly to the fence, i.e. supported above the ground and threaded through or held in the fence material, the sensing fibre would not be at all well coupled to the ground and thus would not be as sensitive to acoustic signals generated from movement on, or disturbance of, the ground in the vicinity of the fence. Such a sensing fibre coupled directly to a fence panel would be highly sensitive to any vibrations resulting from an attempt to climb or cut the fence itself, but these signals would typically swamp any signals due to ground vibration. Burying the fibre thus provides good acoustic coupling for ground vibrations due to movement outside the fence or any digging or tunnelling in the vicinity of the fence.

In order to also provide sensing of any interference with the fence, the members 106 are mechanically coupled to the fence 101 and are also mechanically coupled to the sensing fibre 102. The members 106 act as vibration transmitting elements and couple vibrations from the fence 101 to the sensing optical fibre. This means that the DAS sensor is also sensitive to any vibrations due to interference with the fence itself. Any attempt to climb or cut or otherwise penetrate the fence would create a significant vibration in the fence which would cause vibration of the elements 106. These elements transfer the vibration to the sensing fibre 102 which can be detected by the DAS sensor. The fact that the fibre is buried and that any vibrations generated by direct interaction of an intruder with the fence are transmitted via the members 106 serves to at least partly equalise the relative strength of any vibrations caused by direct interaction with the fence compared to vibrations acoustically coupled via the ground. This means that the sensitivity to both types of stimulus is relatively equalised. Thus a single DAS sensor with a sensing fibre can be used to monitor for both direct interactions with the fence itself, i.e. attempts to cut or climb, as well as ground transmitted disturbances due to movement near the fence or digging etc. and separate sensors for each type of these types of disturbance are not required. Given that a single DAS sensor can monitor a length of optical fibre of up to 40 km or more in length this means that the perimeter monitoring method of the present invention can monitor for both types of disturbance over a long length using a single interrogator unit.

The interrogator unit 103 is located at one end of the sensing fibre. In installations such as monitoring the perimeter of a secure site the sensing optical fibre may be deployed to run into a suitable control room so that the interrogator unit can be located in a convenient location. Clearly this end of the sensing fibre may be located above ground. In embodiments such as monitoring of long borders, such as national borders of the like, the interrogator unit may be located in a suitable control station along or set back from the border being monitored.

In the embodiment shown in FIG. 1 the vibration transfer members 106 extend into the ground and are coupled to the sensing optical fibre underground. This, as mentioned, keeps the optical fibre hidden and out of easy reach of sabotage or vandalism. The lower ends of members 106 will therefore be partly buried. However even when partly buried it has been found that that vibrations generated in the fence can be transmitted to the fibre via members 106, such as tie rods or the like, and generate a detectable signal in the DAS sensor. In fact burying the end of the members 106 may have a slight damping effect on relatively weaker vibrations of the fence, such as due to the wind etc. and thus may help filter out a response to unwanted vibrations. Any significant vibration, such as would be generated by an intruder climbing the fence or attempting to cut or otherwise penetrate the fence would be transmitted to the sensing optical fibre and is clearly detectable.

Conveniently there are a plurality of members 106 coupling the fence 101 to the sensing optical fibre 102. In embodiments such as shown in FIG. 1 where the fence comprises a plurality of fence panels there may be at least one vibration transfer member/element per panel such that each panel is coupled, via at least one appropriate member 106 to the sensing fibre. In embodiments with a continuous fence material the spacing of the members 106 may be chosen according to the application at any desired spacing to ensure that any interaction with the fence such as cutting or climbing with lead to significant vibration of at least one member 106.

It will be noted that the members 106 are visible and thus could be subject to sabotage. However cutting an individual member 106 would likely generate a significant vibration at that location that would be detected by the DAS sensor and cutting an individual member 106 at one location would not interfere with the operation of the perimeter monitoring system at any other location. The sensing fibre itself, being buried is relatively safe from sabotage.

FIG. 1 illustrates that the whole of the sensing fibre is buried in the vicinity of the perimeter to be monitored. It will be appreciated however that at least part of the sensing fibre may emerge from the ground. In some embodiments at least some coupling between the sensing fibre and the barrier may occur above ground—although this may lead to an increased vulnerability to sabotage as compared to a system with a completely buried fibre.

FIG. 1 illustrates the sensing fibre 102 being buried in the ground but in some embodiments at least part of the sensing fibre 102 may be embedded within a foundation for the barrier. For example if the fence is at least part formed by a footing or foundation, say of concrete or cement or the like, at least part of the sensing optical fibre could be embedded within the footing or foundation. Acoustic signals would still be coupled to the fibre embedded within such a material from the surrounding ground and suitable vibration transmitting elements would be able to transmit any vibration due to interference with the fence to the sensing fibre.

In use the sensing optical fibre is interrogated by the interrogator unit to perform DAS sensing. The DAS interrogator unit may be a conventional DAS sensor unit as is known in the art but it may be configured to look for specific or characteristic signals as will be described in more detail below.

FIG. 2 shows a schematic of a conventional distributed fibre optic sensing arrangement. The sensing fibre 102 is removably connected at one end to the interrogator 103. The output from interrogator 103 is passed to a signal processor 204, which may be co-located with, or form part of, the interrogator or may be remote therefrom, and optionally a user interface/graphical display 205, which in practice may be realised by an appropriately specified PC. The user interface may be co-located with the signal processor or may be remote therefrom.

As mentioned the sensing fibre 102 can be many kilometres in length and can be, for instance 40 km or more in length. The sensing fibre may be a standard, unmodified single mode optic fibre such as is routinely used in telecommunications applications without the need for deliberately introduced reflection sites such a fibre Bragg grating or the like. The ability to use an unmodified length of standard optical fibre to provide sensing means that low cost readily available fibre may be used. However in some embodiments the fibre may comprise a fibre which has been fabricated to be especially sensitive to incident vibrations.

In operation the interrogator 103 launches interrogating electromagnetic radiation, which may for example comprise a series of optical pulses having a selected frequency pattern, into the sensing fibre. The optical pulses may have a frequency pattern as described in GB patent publication GB2,442,745 the contents of which are hereby incorporated by reference thereto, although DAS sensors relying on a single interrogating pulse are also known and may be used. Note that as used herein the term “optical” is not restricted to the visible spectrum and optical radiation includes infrared radiation and ultraviolet radiation. As described in GB2,442,745 the phenomenon of Rayleigh backscattering results in some fraction of the light input into the fibre being reflected back to the interrogator, where it is detected to provide an output signal which is representative of acoustic disturbances in the vicinity of the fibre. The interrogator therefore conveniently comprises at least one laser 201 and at least one optical modulator 202 for producing a repeated series of interrogating optical pulses. As mentioned in some embodiments each interrogation may comprise a single pulse of a given frequency. In other embodiments there may be at least two optical pulses separated by a known optical frequency difference in each interrogator. The interrogator also comprises at least one photodetector 203 arranged to detect radiation which is Rayleigh backscattered from the intrinsic scattering sites within the fibre 102. A Rayleigh backscatter DAS sensor is very useful in embodiments of the present invention but systems based on Brillouin or Raman scattering are also known and could be used in embodiments of the invention.

The signal from the photodetector is processed by signal processor 204. The signal processor may for example demodulates the returned signal based on the frequency difference between the optical pulses, such as described in GB2,442,745. The signal processor may also apply a phase unwrap algorithm as described in GB2,442,745. The phase of the backscattered light from various sections of the optical fibre can therefore be monitored. Any changes in the effective optical path length within a given section of fibre, such as would be due to incident pressure waves causing strain on the fibre, can therefore be detected.

For a coherent Rayleigh DAS sensor the backscatter signal received at the detector is an interference signal resulting from backscatter from different parts of the sensing fibre 102 illuminated by the interrogating pulses. The backscatter results from scattering sites within the fibre. For a standard unmodified fibre these scattering sites are the inherent scattering sites that are randomly distributed throughout the fibre, although in some embodiments optical fibres with at least some deliberately introduced scattering/reflection sites may be used. As the scattering sites may be distributed randomly the backscatter signal from any given section of fibre may be random, due to the number of scattering sites but also the distribution and the effect on the overall interference signal. However, in the absence of any environmental stimulus acting on the sensing fibre the scattering from a given sensing portion of the fibre to repeated interrogations with the same interrogating radiation should be the same. Any strain acting on the fibre such as caused by incident acoustic waves or other sources of vibration can cause a change in effective optical path length in that section of fibre. This will result in a change in the backscatter interference signal from that section of fibre. Detecting changes in the backscatter signal from a given sensing portion thus allow detection of acoustic disturbances, i.e. strains or vibrations, acting on the relevant sensing portion of the sensing fibre.

As used in this specification the term “distributed acoustic sensing” will be therefore be taken to mean sensing by optically interrogating an optical fibre to provide a plurality of discrete acoustic sensing portions distributed longitudinally along the fibre and the term “distributed acoustic sensor” shall be interpreted accordingly. The term “acoustic” shall mean any type of pressure wave or mechanical disturbance that may result in a change of strain on an optical fibre and for the avoidance of doubt the term acoustic be taken to include ultrasonic and subsonic waves as well as seismic waves.

The form of the optical input and the method of detection allow a single continuous fibre to be spatially resolved into discrete longitudinal sensing portions. That is, the acoustic signal sensed at one sensing portion can be provided substantially independently of the sensed signal at an adjacent portion. Such a sensor may be seen as a fully distributed or intrinsic sensor, as it uses the intrinsic scattering processed inherent in an optical fibre and thus distributes the sensing function throughout the whole of the optical fibre. The spatial resolution of the sensing portions of optical fibre is determined by the interrogating radiation used and the processing applied and may, for example, be approximately 10 m, which for a continuous length of fibre of the order of 40 km say provides 4000 independent acoustic channels or so deployed along the 40 km of fibre. Thus the entire length of a perimeter of up to 40 km or more may be monitored using a single interrogator and a standard, relatively low cost optical fibre providing a spatial resolution of the order of 10 m or so.

In use therefore the DAS sensor may produce a measurement signal from each of a plurality of sensing portions disposed along the length of the sensing optical fibre. The measurement signal from each sensing channel may be automatically monitored for any signal indicating a potential intruder. This could simply be a measurement signal indicating any significant disturbance in area and/or at a time when no such disturbance is expected. However in some embodiments the DAS sensor system may be arranged to analyse the measurement signals so as to detect particular characteristics associated with certain types of disturbance and/or to look for characteristic vibrational signatures. In some embodiments the DAS sensor system may be able to discriminate between a disturbance due to disturbance of the ground in the vicinity of perimeter and a disturbance due to interference with the fence itself. In some embodiments a processor may therefore process the measurement signals from at least some of the individual sensing portions of the sensing fibre 102.

Disturbances that couple to the fibre via the ground may have a relatively low acoustic frequency. Transmission of acoustic signals through the ground tends to attenuate any higher frequency components. Thus one characteristic that may be used to distinguish between the type of disturbance acting on the sensing fibre may be frequency.

It has been found however that disturbances acting on the sensing fibre due to interference with the fence itself tend to result in relatively high frequency signals in the measurement signals.

The high frequency component may, in some instances be an artefact of the DAS system in response to the higher amplitude strains imparted to the sensing fibre as a result of direct interference with the fence being coupled directly to the sensing fibre by the vibration sensing elements. Recall that coherent Rayleigh based DAS sensing is based on changes in an interference signal due to the change in backscatter from the scattering sites of the fibre in response to a path length change. For a DAS sensor that uses a single interrogating pulse of a given optical frequency, any disturbance on the optical fibre is detected by monitoring a change in intensity due to the path length change. Thus for a given sensing portion a certain small optical path length change will result in an intensity fluctuation, say an increase. If a repeating stimulus therefore repeatedly causes this small path length change the resulting backscatter signal will exhibit an intensity variation at the frequency of the stimulus. If however the stimulus causes a bigger path length change, say of the order of 27, then a single instance of the path length change will result in the measurement signal to go through a full phase cycle of the interference signal and thus the backscatter intensity will also go through a full cycle of increasing then decreasing or vice versa. Were such a higher amplitude path length change to occur at a first frequency the resulting backscatter interference signal would appear to have an intensity modulation at twice the first frequency. This signal wrapping effect at high applied strains, such as would be expected when the fence is directly interfered with and large amplitude vibrations are transmitted to the sensing fibre (especially compared to the likely strains imparted to vibrations transmitted through the ground), thus results in apparent high frequency components in the measurement signals from the DAS sensor. It should be noted that the actual vibrations induced in the fence and the vibration transfer elements are not necessarily inherently high frequency but result in a high frequency component in the DAS sensor.

Thus any significant high frequency components in a measurement signal from the DAS sensor may be likely to be from, i.e. due to, vibrations transmitted via the vibration transmission elements, i.e. members 106, rather than any acoustic stimulus transmitted via the ground.

This provides a means by which to discriminate signals detected by a sensing portion of the DAS sensor due to, e.g. someone walking on the ground near the perimeter, or a vehicle driving near the perimeter or even digging in the vicinity of the perimeter, from the signals due to climbing or cutting of the fence.

Embodiments of the present invention therefore may analyse the measurement signals from the sensing portions of the DAS sensor to detect any anomalous signals that may indicate an intruder. The measurement signals may also be analysed to discriminate between various possible events of interest, for instance cutting or climbing of the fence that may result in a significant high frequency component or movement or activity on the ground in the vicinity of the perimeter. In the event that an event of interest is detected various actions could be taken. For instance an alarm or alert could be generated based on the type of detected event. If other intrusion detection systems are present, such as infrared sensors of the like the detected event from the DAS system could be correlated with the outputs of other monitoring systems. If present, appropriate cameras could be activated and/or directed towards the appropriate location. It will be understood that DAS provides not only the detection of an event of interest but also the location along the sensing fibre and hence the location along the perimeter.

As mentioned any suitable vibration translation element could be used and the vibration translation element could be arranged to provide a particular vibrational stimulus to the sensing fibre in response to interference with the fence.

FIG. 3a illustrates an alternative embodiment of the present invention. FIG. 3 illustrates a side view of a barrier, which in this embodiment is a wire fence 101. Again a sensing optical fibre 102a is buried to run largely alongside the path of fence 101. In this embodiment the vibration translation elements comprise at least one cable 301. The cable 301 is attached to the fence in at least one location and is also coupled to the sensing optical fibre 102a. The cable 301, which may be a metal cable or the like, may be attached so as to be under tension. This ensures that any vibration acting on the fence is transmitted, via the cable, to the sensing optical fibre. Keeping the cable under tension also keeps the fence under some tension which may help prevent vibration due to wind etc. The vibration transmitting element may therefore comprise a tensioning element 302 which acts to keep the cable under tension. The cable 302 may extend inwards with respect to the perimeter to be secured, i.e. the cable reaches the ground within the perimeter. Thus the sensing fibre may be deployed with the perimeter to be monitored.

Additionally or alternatively a sensing fibre 102b could be buried so as to lie outside the perimeter. This may maximise the sensitivity of the sensing fibre to stimuli generated in the ground just outside the perimeter. In this case at least part of the vibration transmitting element could be buried. For instance FIG. 3a illustrates a vibrational translation element which connects to the fence and which extends underground to the sensing fibre 102b.

In some embodiments the vibration transmitting element could comprise a movable part which is coupled to the sensing optical fibre and the fence and at least one shield or guiding component that allows the movable part to move. For example vibration transmitting element 303 could, as shown in FIG. 3b, comprise a cable 305 under tension within a sheath. The sheath may be buried and held in place allowing the central cable to move to transmit vibrations from the fence to the sensing fibre 102b.

In some embodiments there may additionally be at least part of a sensing fibre 102c which is deployed along side the sensing fibres 102a and/or 102b. Sensing fibre 102c is buried alongside the perimeter but is not coupled to any vibration transmitting elements and thus is only responsive to stimuli transmitted via the ground. The response from the sensing portions of sensing fibre 102c may be used to process the response from the sensing portions of sensing fibre(s) 102a and/or 102b to help discriminate between signals due to interference with the fence and other signals transmitted through the ground. Sensing fibre 102c could be a separate sensing fibre to the sensing fibre(s) 102a or 102b which is/are coupled to the fence, either multiplexed to the same interrogator unit or with its own dedicated interrogator unit and/or sensing fibres 102a/102b and 102c may be implemented by different parts of a single optical fibre being looped accordingly.

The embodiments above have been described with respect to chain-link fences and the like however embodiments of the invention may be applied to any type of wire fence or indeed any flexible barrier that may undergo significant vibration in response to an intruder climbing the barrier or attempting to penetrate the barrier. Indeed embodiments of the invention may also be applied to even relatively inflexible barriers where significant destruction or penetration of the barrier could result in significant vibrations being generated and transmitted via a vibration transmitting element.

It should be noted that the above-mentioned embodiments illustrate rather than limit the invention, and that those skilled in the art will be able to design many alternative embodiments without departing from the scope of the appended claims. Features from various embodiments may be combined and used together except where expressly indicated otherwise. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A system for monitoring a perimeter having a barrier comprising:
a sensing optical fibre suitable for fibre optic distributed acoustic sensing deployed along at least part of said perimeter;
at least part of said sensing optical fibre being buried in the vicinity of at least part of said barrier;
wherein the sensing fibre is mechanically coupled to at least one vibration transmitting element which is mechanically coupled to the barrier.

2. (canceled)

3. A system as claimed in claim 1 wherein said barrier comprises a chain-link or wire fence.

4. A system as claimed in claim 1 where the vibration transmitting element is coupled to the optical fibre below ground.

5. A system as claimed in claim 1 where the vibration transmitting element is coupled to the barrier above ground.

6. A system as claimed in claim 1 where the vibration transmitting element is coupled to the barrier in multiple places.

7. A system as claimed in claim 1 wherein the vibration transmitting element comprises an elongate rigid element.

8. A system as claimed in claim 1 wherein the vibration transmitting element comprises a rod or stick.

9. A system as claimed in claim 7 wherein the vibration transmitting element extends for at least half the height of the barrier.

10. A system as claimed in claim 7 wherein the end of the vibration transmitting element that is coupled to the sensing fibre comprises a portion aligned with the direction of the sensing fibre.

11. A system as claimed in claim 1 wherein the vibration transmitting element comprises a cable under tension.

12. (canceled)

13. A system as claimed in claim 1 wherein the vibration transmitting element comprises a movable part which is coupled to the sensing optical fibre and the fence and at least one shield or guiding component that allows the movable part to move.

14. A system as claimed in claim 1 wherein the sensing fibre is not visible from above ground in the vicinity of the barrier.

15. A system as claimed in claim 1 wherein at least parts of the sensing fibre directly underlie the fence.

16. A system as claimed in claim 1 wherein at least parts of the sensing fibre are buried to lie outside the perimeter.

17. A system as claimed in claim 1 comprising a distributed acoustic sensor coupled to one end of said sensing fibre wherein said distributed acoustic sensor is configured to produce a measurement signal from each of a plurality of sensing portions disposed along the length of the sensing optical fibre, the system further comprising a processor configured to monitor the measurement signal from each sensing channel for any signal indicating a potential intruder.

18. (canceled)

19. A system as claimed in claim 17 wherein said processor is configured to analyse said measurement signals for a any significant disturbance in area where and/or at a time when no such disturbance is expected.

20. A system as claimed in claim 17 wherein said processor discriminates between a disturbance due to disturbance of the ground in the vicinity of perimeter and a disturbance due to interference with the fence itself.

21. A system as claimed in claim 20 wherein said processor discriminates between a disturbance due to disturbance of the ground in the vicinity of perimeter and a disturbance due to interference with the fence itself by analysing any high frequency component of the measurement signals.

22. A system as claimed in claim 17 where said distributed acoustic sensor analyses the amount of high frequency content in the measurement signal from a sensing portion of the sensing fibre to detect an event associated with interference with said barrier.

23. A method of monitoring a perimeter having a barrier comprising:
performing distributed acoustic sensing on a sensing optical fibre deployed along at least part of said perimeter;
wherein at least part of said sensing optical fibre is buried in the vicinity of at least part of said barrier; and
wherein the sensing fibre is mechanically coupled to at least one vibration transmitting element which is mechanically coupled to the barrier.

24. (canceled)
